(19) United States
(12) Patent Application Publication
(10) Pub. No.: US 2010/0265472 A1
(43) Pub. Date: Oct. 21, 2010

(54) Methods and Systems for Laying Out a Design

(76) Inventor: Chris Campbell, Spring, TX (US)

Correspondence Address: WINSTEAD PC, P.O. BOX 50784, DALLAS, TX, 75201, US

(21) Appl. No.: 12/704,338

(22) Filed: Feb. 11, 2010

Related U.S. Application Data
(60) Provisional application No. 61/207,870, filed on Feb. 11, 2009.

(51) Int. Cl. G03B 21/20

(52) U.S. Cl. 353/85; 353/121

(57) ABSTRACT

A design layout projection system including a cube-like, solid case and housing compartment encasing several components including a laser projector system, a built-in computationally controlled system, multiple input and output connectors, a scaling knob, on/off switch and a power supply for projecting construction designs unto a work surface by inputting different types of input files, generating different output levels depending on the laser type used and optimizing and guiding the generated images unto a work surface.

### FIELD OF INVENTION

The present invention relates to the field of laser projection systems and, more particularly, but not by way of limitation, to a device, system and method for laying out construction design plans and drawings using a laser projection system.

### BACKGROUND OF THE INVENTION

Large-scale industrial laser projections systems for projecting images unto a surface have been commercially available for a while with some measured success for their intended purposes. They have nevertheless exhibited limitations in speed, projecting high-resolution precision images and exhibiting curvatures in design and construction layouts. Additionally, some of these systems are too complicated, cumbersome, inefficient and not very cost effective due to high operational and maintenance costs.

For the aforementioned reasons, there is a widely recognized need in the art for, and it would be highly advantageous to have, a faster, more accurate, and easier layout system for presentation of construction plans and designs.

### SUMMARY OF THE INVENTION

The present invention relates to a device, system, and method for laying out construction design plans and drawings using a laser projection system. In one embodiment, a design layout projection system is disclosed. The design layout projection system further includes a drawing input source and a design layout projection device for generating precise designs including curved designs which are then projected unto a work surface.

Another embodiment discloses a design layout projection device which includes a cube-like, solid case and housing compartment encasing several components including a laser projector system with multiple laser sources for generating different output levels; a built-in computationally controlled system for generating precise designs including curved designs; multiple input and output connectors; a scaling knob; on/off switch and a power supply.

A method for projecting construction or design plans onto a variety of surfaces using the design layout projection device is also disclosed. The method includes generating a design layout, by inputting drawings from a designated input source to generate different output levels depending on the laser source used. Next, achieving optimal results through algorithms in a built-in computationally controlled system to direct and harness the fine points and curves of the design; and projecting a high precision image unto the ground from which the layout, construction, or excavation of pool, deck or any other sight might be undertaken.

The forgoing has outlined some of the features and technical advantages of the present invention in order that the detailed description of the invention that follows may be better understood. Additional features of the invention will be described hereinafter which form the subject of the claims of the invention.

### BRIEF DESCRIPTION OF THE DRAWINGS

A more complete understanding of the system of the present invention may be obtained by reference to the following Detailed Description when taken in conjunction with the accompanying Drawings wherein:

FIG. 1 is a design layout projection device for laying out construction design plans and drawings in accordance with an embodiment of the present invention;

FIG. 2 is a close up of the design layout projection device for laying out construction design plans and drawings in accordance with an embodiment of the present invention of FIG. 1.

FIG. 3 is a schematic diagram of a design layout projection system in accordance with an embodiment of the present invention.

The above Drawings are not necessarily to scale. Furthermore, the shape and location of the objects in the Drawings are approximate and could vary in other embodiments.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is understood that the various embodiments of the invention, although different, are not mutually exclusive. For example, a particular feature, structure, or characteristic described herein in connection with one embodiment may be implemented within other embodiments without departing from the spirit and scope of the invention. In addition, it is understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with a full range of equivalents to which the claims are entitled. In the drawings, like numerals refer to the same or similar functionality throughout the several views.

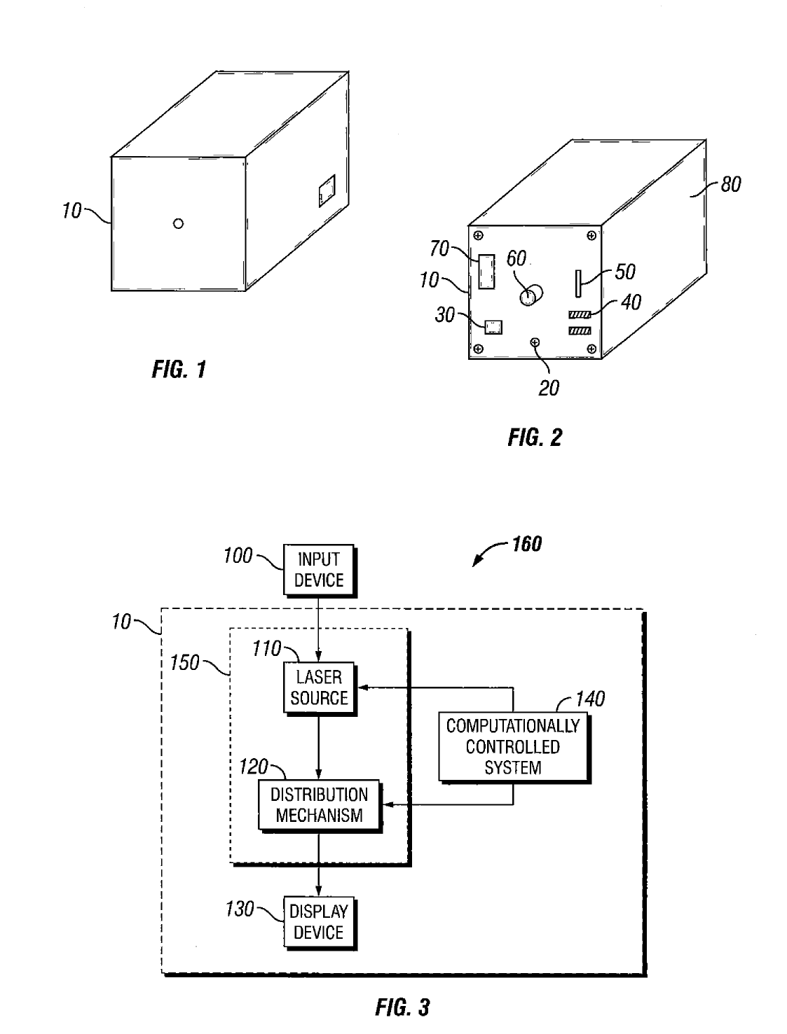

FIG. 1 and FIG. 2 show an embodiment of a self-contained design layout projection device 10 for laying out construction design plans and drawings. In this embodiment, the device 10 includes a cube-like, solid construction precision machined aluminum case and housing compartment 80 of approximately 6″×6″ in dimensions that encases several components. Such components include a scaling knob 60, on/off switch 70, a power supply source 20, and other components (such as an amulet-color output, wireless connection, removable media input 50 and built in memory, multi-color output, rechargeable internal power or wall plug, a tripod, enhancer glasses, carrying case, assorted cables, media cards 40, and preloaded drawings) to be described later. Furthermore, on site scaling of the drawings is possible by a control knob 60 which can be displaced clockwise or counter-clockwise to achieve the desired dimensions.

As shown in FIG. 3, device 10 in further embodiments may also comprise a built-in computationally controlled system 140, a laser projection system 150 with a laser light source 110 and a beam distribution mechanism 120, and a display device 130. Such components are parts of the design layout projection system 160.

With reference to the design layout projection system 160 of FIG. 3, the laser beam or beams generated by one of a number of laser sources 110 is transmitted to the distribution mechanism 120, which is an optically enhancing system that creates the desired visual effects by either coloring the laser beams or shaping and redirecting the path of the laser beam to produce the image 130 of the design layout. The beam distribution mechanism 120 may comprise any conventional beam distribution system configured to accept the laser beams produced by the input source. Upon receipt of the laser beams, the distribution mechanism 120 distributes the laser beams to its various components such as, but not limited to, solenoids, galvanometers, refraction devices, mirrors and filters which manipulate the laser beams to form an image of the design that is then projected to the construction surface as an image 130 of the design layout. The color enhancement component comprises filters. The beam shaping and directing component includes a mirror set mounted on galvanometers in an X/Y orientation with one mirror sweeping the laser beam along an arc about X axis, and the other sweeping the beam through another arc about the Y axis. The refractive and diffractive components of the beam distribution mechanism 120 that change the optical and visual properties of the generated laser beams are mounted on solenoids effected by a computationally controlled system 140.

This built-in computationally controlled system 140 generates precise images of design layouts. For example, the sweeping motion and components of the distribution mechanism 120 can be controlled by a galvanometer steering system, such as the EC 1000 system from Cambridge Technology. The EC 1000 controller system is a fully integrated dual system-on-chip (SoC) control system designed to be embedded into a scanning head without the need for a host computer for operation. In another embodiment, the Cambridge Technology Digital Control Center Model 2000 Series with simulated based pre-filtering algorithms for motion control optimization and galvo parameter identification and fitting can improve the accuracy and positioning of the images produced and projected onto the construction surface. These real-time computer integrated systems 140 control the scanning heads and the projection systems and are arranged for real time control of the images produced by the system through manipulation of the inputted drawings in the laser projection system 150 such that the net effect is the projection of accurate depictions of design layout, including geometric or freeform curved designs or designs with a significant radius of curvature. Such depictions may also include additional features of the inputted drawings, such as plumbing networks, electrical networks, steel reinforcements, perimeters of various structures.

Data in the form of at least one of, but not limited to manual drawings, CAD drawings, vector or raster graphics, Pool Studio Drawings, DXF, and ILDA format files is inputted through at least one of the USB, Ethernet, removable media, or wireless connectors and processed with the design image projected unto a surface. The beam, color and scanner driver cards as well as the beam, color and scanner driver power supplies used by the solenoids and the galvanometers in the distribution mechanism have the capability of converting VAC to VDC. Furthermore, the design layout projection device or system can be upgraded with the use of either an amulet-color output, wireless connection, removable media input and built in memory, multi-color output, rechargeable internal power or wall plug. Additionally, accessories include a tripod, enhancer glasses, carrying case, assorted cables, media cards, and preloaded drawings while multiple devices could also be linked together for large or complex plans. The result is a design layout projection device 10 or system 160 for laying out construction design plans and drawings that is fast, cost effective, portable, projects high-resolution precision images and exhibits curvatures in design and construction layouts. Additionally, the design layout projection device 10 and system 160 eliminate inefficiencies, providing an improved and faster design layout by turning out a 2.5-3 hour layout in less than 20 minutes or reducing the time it takes to layout a site plan by at least 75%.

The design layout projection device 10 and system 160 can also provide guidelines for various aspects of design plans, such as utilities, foundations, piers, footings, landscape placement, hand sculpting concrete (such as gunite), and other aspects.

Referring now to FIG. 3 projecting design layouts unto surfaces involves feeding the relevant drawings into the design layout projection device 10 through one of several input connectors. With one or more input 100 and output 130 connection options, different output levels can be produced, depending on the laser source 110 used. The laser beam generated is fed into an optical coupler and injected into an optical fiber which carries the laser beam to a distribution mechanism 120 which contains the scanner driver power supply, the scanner driver card and scanning means, e.g., a mirror set mounted on a set of galvanometers mounted on an X/Y galvanometer mount and controlled by drive cards which are further controlled by a digital/analog interface card. The beams are then directed by an integrated computationally controlled system 140, through the refractive and diffractive distribution mechanism, where the beam is visually and optically enhanced such that the details and curved outlines of the design are displayed in real-time while significantly improving or reducing the time it takes to layout a site plan. The image of the design is then projected onto a construction surface such as a pool, deck or any other construction site.

One of ordinary skill in the art will recognize that the present invention has numerous embodiments. For instance, device 10 and system 160 may utilize multiple colors that symbolize or distinguish different aspects of a plan. More particularly, in one embodiment, the plumbing components in an image could be in blue, and the electric components in an image could be in red. In further embodiments, the center-points of radii may be marked onto a surface if they are on the drawing. More broadly, anything drawn on the plan can be displayed. Furthermore, device 10 and system 160 may be used to remark or locate improvements for structures at a later time.

Although various embodiments of the design layout projection system have been illustrated in the accompanying Drawings and described in the foregoing Detailed Description, it will be understood that the invention is not limited to the embodiments disclosed, but is capable of numerous rearrangements, modifications, and substitutions without departing from the spirit of the invention as set forth herein.

What is claimed is:

1. A design layout projection system comprising:
an input source; and
a design layout projection device which generates and projects images of a design layout onto a work surface.

2. The system of claim 1 wherein the design layout projection device further comprises:
a laser projector system for projecting an image onto the work surface;
a computationally controlled system for generating precise designs including curved designs;
multiple input connectors;
multiple output connectors;
a scaling knob to allow the user to scale the size of the image;
an on/off switch;
a power supply; and
a case to house the laser projector system, the computationally controlled system, the multiple input connectors, the multiple output connector, the scaling knob, the on/off switch and the power supply.

3. The system of claim 2 wherein the solid case is a cube of about six inches per side.

4. The system of claim 2 wherein the laser projector system further comprises:
a plurality of laser sources for generating a plurality of laser beams; and
a distribution mechanism.

5. The system of claim 4, wherein the distribution mechanism comprises of a scanning head for directing the laser beams.

6. The system of claim 5, wherein the scanning head comprises of a mirror set placed on galvanometers controlled by drive cards, further controlled by a digital/analog interface card and mounted in an X/Y galvanometer mount.

7. The system of claim 2, wherein the built-in computationally controlled system is real-time embedded control system.

8. The system of claim 7 wherein the built-in computationally controlled system further comprises:
a fully integrated dual system-on-chip (SoC) control system for controlling the sweeping motion and components of the distribution mechanism; and
a digital control center for motion control optimization and galvo parameter identification and fitting.

9. The system of claim 8 wherein the a digital control center further comprises:
algorithms that improve the accuracy and positioning of the images produced and projected onto the construction surface.

10. A design layout projection device comprising:
a laser projector system for projecting an image onto the work surface;
a computationally controlled system for generating precise designs including curved designs;
multiple input connectors;
multiple output connectors;
a scaling knob to allow the user to scale the size of the image;
an on/off switch;
a power supply; and
a case to house the laser projector system, the computationally controlled system, the multiple input connectors, the multiple output connector, the scaling knob, the on/off switch and the power supply.

11. The device of claim 10 wherein the solid case is a cube of about six inches per side.

12. The device of claim 10 wherein the laser projector system further comprises:
a plurality of laser sources for generating a plurality of laser beams; and
a distribution mechanism.

13. The device of claim 12, wherein the distribution mechanism comprises of a scanning head for directing the laser beams.

14. The device of claim 13, wherein the scanning head comprises of a mirror set placed on galvanometers controlled by drive cards, further controlled by a digital/analog interface card and mounted in an X/Y galvanometer mount.

15. The device of claim 10, wherein the built-in computationally controlled system is real-time embedded control system.

16. The device of claim 15 wherein the built-in computationally controlled system further comprises:
a fully integrated dual system-on-chip (SoC) control system for controlling the sweeping motion and components of the distribution mechanism; and
a digital control center for motion control optimization and galvo parameter identification and fitting.

17. The device of claim 16 wherein the a digital control center further comprises:
algorithms that improve the accuracy and positioning of the images produced and projected onto the construction surface.

18. A method for laying out a design with a design layout projection device comprising:
inputting the design into the laser projection system of the design layout projection device;
generating a laser beam dependent on the laser source used;
directing the laser beam through a distribution mechanism of the design layout projection device;
visually and optically enhancing the beam with a real-time, built-in computationally controlled system of the design layout projection device to account for design details and curvature; and
projecting the enhanced laser beam unto a work surface.

19. The method of claim 18 wherein the drawings can be scaled on site by rotating the scaling knob clockwise or counter-clockwise to achieve the required dimensions.
